(19) United States
(12) Patent Application Publication
(10) Pub. No.: US 2012/0244399 A1
(43) Pub. Date: Sep. 27, 2012

(54) BATTERY PACK THERMAL VENT PROTECTION

(75) Inventor: Steven Tartaglia, Safety Harbor, FL (US)

(73) Assignee: LITHIONICS, LLC, Safety Harbor, FL (US)

(21) Appl. No.: 13/070,736

(22) Filed: Mar. 24, 2011

(51) Int. Cl. H01M 2/12

(52) U.S. Cl. 429/82

(57) ABSTRACT

A battery pack includes a set of walls made of sturdy material, power interface terminals and battery cells and optionally electronics held within the walls. A spring-loaded check valve installed in a wall of the enclosure fluidly connects an area within the enclosure with an atmosphere outside of the enclosure. The one-way check valve allows pressurized fluids to flow out of the enclosure while preventing pressurized fluids from flowing from the atmosphere into the enclosure.

### CROSS-REFERENCE TO RELATED APPLICATION

This is a related to U.S. patent application titled “BATTERY CUSHION AND INSULATOR,” Ser. No. 12/786,473, attorney docket 3037.0, inventor Steven Tartaglia, filed May 25, 2010 and U.S. patent application titled “BATTERY PACK THERMAL PROTECTION FROM HEAT STERILIZATION,” Ser. No. 12/789,597, attorney docket 3044.0, inventor Steven Tartaglia, filed May 28, 2010. The contents of both applications are hereby incorporated by reference.

### FIELD

This invention relates to the field of batteries and more particularly to a system for venting battery packs when external heat is introduced such as during thermal sterilization.

### BACKGROUND

Battery cells such as flooded lead-acid, absorbed-glass-matt (AGM), lead-acid, Nickel Cadmium (NiCd), Nickel Metal Hydride (NiMh) and the like perform best at certain temperature ranges and are easily damaged when exposed to very high temperatures. When such battery cells, either standalone or within a battery pack, are exposed to certain high temperatures, various physical changes occur internal to the battery cells such as boiling of the electrolyte, etc. In an extreme case, such as boiling of the electrolyte, high pressure results within the sealed cell, leading to possible deformation of the outer case, deformation of the anode/cathode arrangements and, possible out-gassing or leakage of electrolyte, the later of which resulting in a totally useless cell.

Many hospital or surgical related devices use battery packs, providing enhanced range of motion to surgeons and reducing the chance of a power cord finding its way into a bad location. There are many examples of such devices for drilling into bone, sawing bone, screwdrivers, making incisions, etc. These devices use battery packs that attach to the devices and provide power during, for example, an operation such as an orthopedic operation. In most systems, the battery pack is removable for charging in a charging station.

A recent search indicates that many battery packs for such devices contain the heavy metal cadmium, Cd. The labels of these batteries show the chemical symbol, Cd, along with a crossed-out trash can, meaning that these batteries are not to be disposed of in ordinary trash due to land, water table and air pollution from landfills or incinerators.

Once battery packs for medical devices are depleted and no longer provide ample charge for operating their intended equipment, the entire pack is discarded. This creates a dilemma because the battery packs are often exposed to body fluids, making them a bio-hazard. Bio-hazard material is often incinerated to neutralize the hazard, but most batteries cannot be incinerated due to pollution and/or explosion issued. Therefore, the battery packs should not be placed in bio-hazard disposal containers, yet, since they are now bio-hazardous, the exposed battery packs cannot be disposed in normal recycle locations.

A majority of such battery packs currently being marketed are rechargeable and reusable, much like a battery pack for a home cordless drill. After use and/or before the next usage, the device and the battery packs must be sterilized to kill any pathogens present on surfaces and in cracks, etc. To sterilize a rechargeable battery pack, per one exemplary manufacturer's procedure, the battery pack is separated from the device and any debris or accumulation is cleaned. Next, sterilization is performed through an Autoclave Cycle. Autoclave cycles are, for example, 132° C.-137° C. for at least 15 minutes then 5 minutes drying time or 15 minutes of pre-heating, 132° C.-137° C. for at least 10 minutes, then 5 minutes drying time. Another, more typical autoclave cycle is 138° C. for 50 minutes in 28 PSI (pounds per square inch) pressurized steam.

Such cycles, although hard on mechanical devices such as motors, usually do not severely affect the life of the actual devices. A key feature of most, if not all, battery packs is a vent. The vent is provided to expel gases that are potentially produced by the cells within the battery pack as may occur during charging. The vent is needed to reduce the internal pressure within the battery pack so that it does not reach a point at which the sealed case of the battery pack ruptures or explodes.

For many non-medical applications, a simple air hole or other opening is sufficient to allow this potential pressure to escape. Such systems work well for applications such as notebook computers, etc., but are not acceptable in medical applications for several reasons, including introduction of biomaterial into the battery pack and introduction of moisture into the battery pack during the autoclave cycles. It is very difficult to sterilize biomaterial that has entered into a cavity such as the internal cavity of the battery pack. Also, moisture entering from the autoclave cycles will increase the weight of the pack, shorten the lifespan of the pack due to corrosion and shorten charge due to internal conduction.

To reduce the introduction of biomaterial into the battery pack and introduction of moisture into the battery pack during the autoclave cycles, a one-way valve replaces the vent hole or opening, allowing internal pressure to escape while blocking external fluids from entering the battery pack. While several initial attempts at integrating one-way valves into battery packs have met the primary goal of venting gases and reducing the possibility of explosion, these attempts have not succeeded at preventing introduction of fluids into the battery pack.

What is needed is a battery pack with a one-way vent that prevents introduction of moisture into the battery pack during autoclave and reduces accumulation of biomaterial during use providing for thorough sterilization during autoclave.

### SUMMARY

A battery pack is disclosed including a set of walls made of sturdy material, power interface terminals and battery cells and optionally electronics held within the walls. A spring-loaded check valve installed in a wall of the enclosure fluidly connects an area within the enclosure with an atmosphere outside of the enclosure. The one-way check valve allows pressurized fluids to flow out of the enclosure while preventing pressurized fluids from flowing from the atmosphere into the enclosure.

In one embodiment, a battery pack is disclosed including an enclosure with one or more battery cells held within the enclosure. A one-way check valve, the one way check valve passes through a wall of the enclosure and fluidly connects an area within the enclosure with an atmosphere outside of the enclosure. The one-way check valve allows pressurized fluids to flow out of the enclosure while preventing pressurized fluids from flowing from the atmosphere into the enclosure.

In another embodiment, a method of reducing battery cell failure during heat sterilization is disclosed including providing one or more battery cells, the battery cells being interconnected (series, parallel or series-parallel) to provide power to a device. The battery cells are enclosed into a battery pack in which the connection terminals are accessible from outside of the battery pack. A one-way check valve is affixed into a hole in a wall of the enclosure. The one way check valve fluidly connects an area within the enclosure with an atmosphere outside of the enclosure, allowing pressurized fluids to flow out of the enclosure and preventing pressurized fluids from flowing from the atmosphere into the enclosure. Thereby, pressurized steam presented during a heat sterilization cycle is prevented from entering the battery pack by the one-way check valve while abnormal pressure from within the enclosure escapes through the one-way check valve and to the atmosphere, reducing the potential for bursting and/or explosion.

In another embodiment, a battery pack is disclosed including an enclosure that holds two or more battery cells. Conductive paths interconnect battery terminals of the battery cells in series, parallel or series-parallel configurations. A connection terminal that has electrical contacts is on or molded into the enclosure so that the electrical contacts are accessible from outside of the enclosure. A one-way check valve is sealedly installed in a wall of the enclosure. The one-way check valve fluidly connects an area within the enclosure with an atmosphere outside of the enclosure and allows pressurized fluids to flow out of the enclosure while preventing pressurized fluids from flowing from the atmosphere into the enclosure. The one-way check valve comprises of a valve seat, a valve ball, a vented enclosure and a spring. The spring urges the valve ball against the valve seat. The valve seat is fluidly interfaced to the area within the enclosure.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a cut away view of a typical battery pack of the prior art.

FIG. 2 illustrates a perspective view of a typical battery pack of the prior art.

FIG. 3 illustrates a perspective view of a battery pack with improved venting.

FIG. 4 illustrates an exploded view of a battery pack with improved venting.

FIG. 5 illustrates a cross-sectional view of a battery pack with improved venting.

FIG. 6 illustrates a cross-sectional view of a typical one-way valve.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

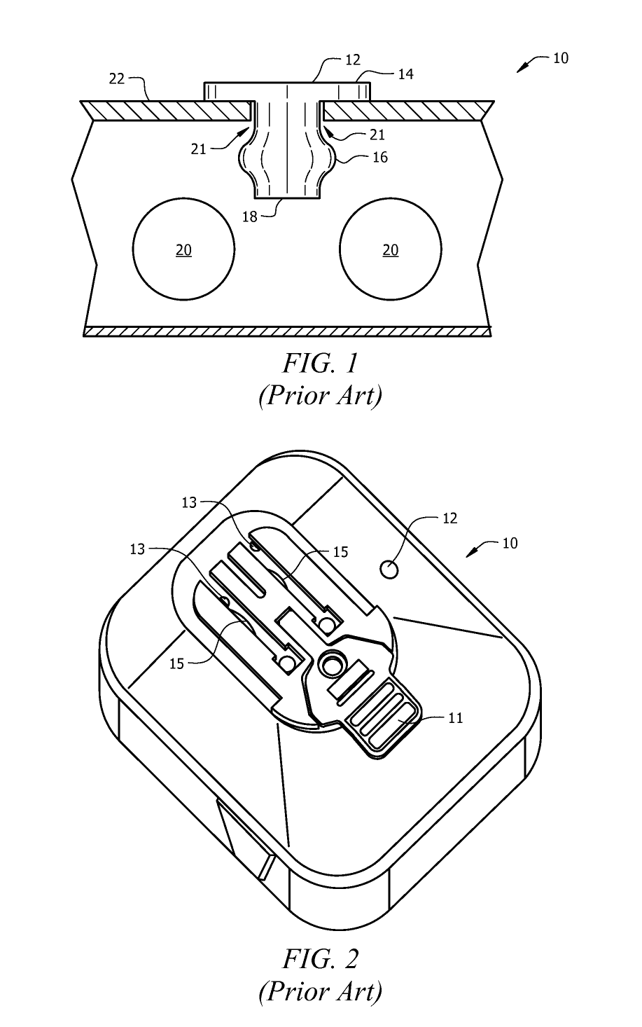

Referring to FIGS. 1 and 2, views of a typical battery pack 10 of the prior art will be described. Typical battery packs 10 have a rigid enclosure 22, usually made of Acrylonitrile butadiene styrene otherwise known as ABS. Within the plastic enclosure 22 are one or more battery cells 20 connected in series, parallel or series/parallel by interconnecting conductive paths (not shown) which are typically flat metal sheets that are tack-welded to battery terminals as known in the industry. One or more battery terminals are connected to a power connection terminal 15 for the delivery of power to a device and for the charging of the battery cells 20. In many battery packs 10, the battery pack 10 engages with a device (e.g. drill, saw, etc.) through a rail 13 and latch 11 system, although other attachment systems are also used to secure the battery pack 10 to the device during use and to conduct electricity to/from the battery pack 10 during use and/or charging. Often, the same rail 15, contact 15 and latch 11 system is used to hold the battery pack 10 in a charging cradle (not shown).

Although not shown, for completeness, often such battery packs 10 include other devices such as electronic circuits that prevent over current, over voltage, under voltage, control charging, prevent over-temperature situations during charging, etc. All such devices are known and present in some battery packs 10, but have been left out for clarity reasons.

Battery packs for general purpose use often release unexpected internal pressure through a simple pressure relief system such as a vent hole, a vent hole covered by a label, an area of the case that is thinner and breaks under pressure, etc. Such venting is not intended for medical purposes because of the heat and pressure to which the battery pack is subjected during sterilization. These systems are likely to fail under the pressure of a typical autoclave cycle, enabling the introduction of moisture, water and biohazard material into the internal cavities of the battery packs. The exemplary battery pack 10 of the prior art, shown in FIGS. 1 and 2, has a simple device 12/14/16/18 that is an attempt to prevent the introduction of moisture, water and biohazard material into the internal cavities of the battery pack 10. In this, a one-way valve 12 is formed in the shape of a “T” having a planar top 14 that is larger than a hole 21 in the battery pack, a typically cylindrical shaft 18 that extends through the wall 22 of the battery pack 10 and a bulge or dimple 16 that is slightly wider than the hole 21. The entire valve 12 is made from a rubber material that helps provide a seal between the case wall 22 and the planar top 14. Since the rubber material is pliable, during manufacture the shaft 18 of the valve 12 is inserted through the hole 21 and the bulge/dimple 16 deforms enough to enable installation, then restores to its original size/shape, thereby holding the valve 12 in place.

When such a battery pack 10 is placed in a sterilizing chamber such as an Autoclave during a sterilization cycle, external temperatures rise to a temperature between 132° C. and 138° C. and steam pressure is introduced at around 28 PSI. This temperature and pressure is typically maintained for 50 minutes. Under pressure, the valve 12 of the prior art is pushed against the wall 22 of the battery pack 10, but due to manufacturing and material tolerances, steam under pressure finds its way between the enclosure wall 22 and the valve planar top 14 and into the battery pack 10. Additionally, during use, since pressure differences between outside and inside of the battery pack 10 vary as the battery cells 20 within the battery pack 10 heat and cool, biohazard material often finds its way beneath the planar top 14 and into the battery pack 10.

It has been found that some hospitals are performing short-cycle autoclave procedures on such battery packs 10 to reduce filling of the battery packs 10 with moisture from the high pressure steam. It has also been found that cases of certain infections such as staff infections increase when less-than adequate sterilization processes are used.

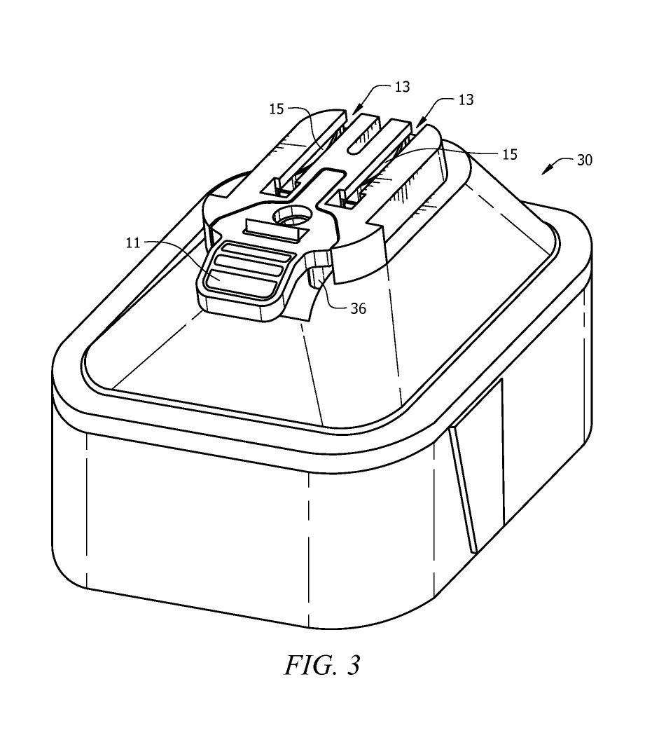

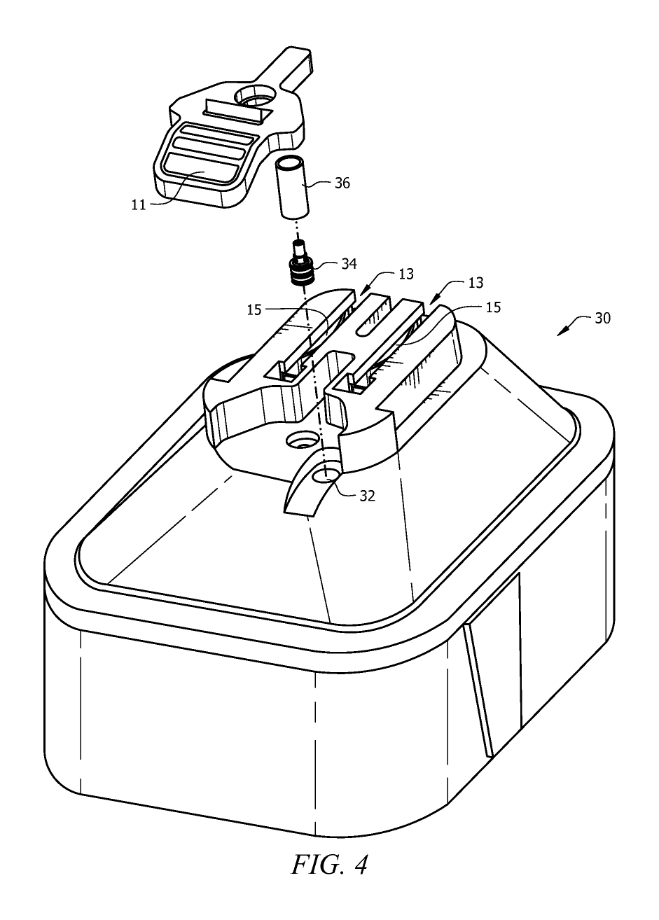

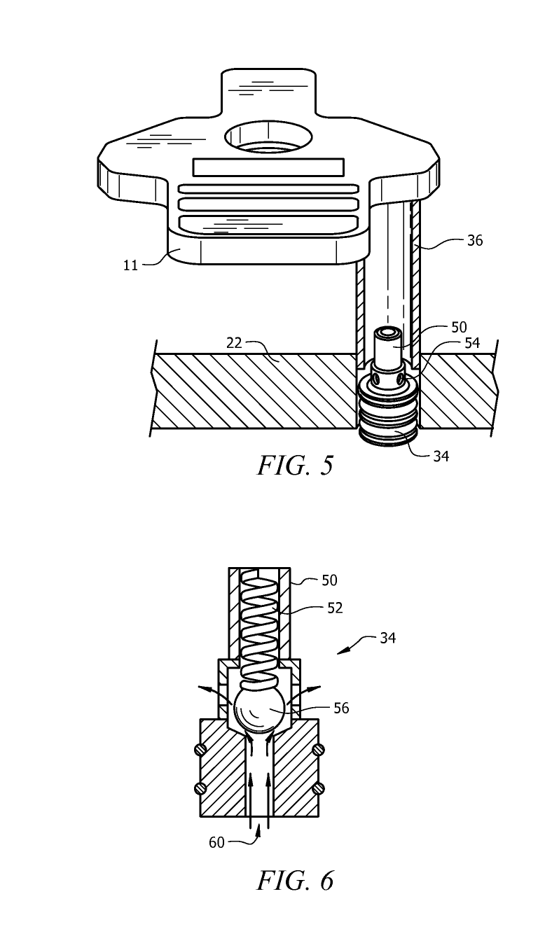

Referring to FIGS. 3, 4 and 5, views of a battery pack 30 with an improved venting system are described. The improved battery packs 30 have an enclosure 22, made of any known rigid material such as ABS or a more heat resistant plastic such as Ultem from GE plastics. Within the enclosure 22 are one or more battery cells 20 (not visible) connected in series, parallel or series/parallel by interconnecting conductive paths (not visible), typically flat metal sheets that are tack-welded to battery terminals. Any known or future battery chemistry is anticipated including, but not limited to, alkaline, lead acid, nickel cadmium, nickel metal hydride, lithium, lithium ion, mercury, lithium iron, etc.

One or more battery terminals are connected to power connection terminals 15 for the delivery of power to a device and for the charging of the battery cells 20. Although, one specific configuration of connection terminals 15 is shown, any known connection configuration is anticipated. In a preferred embodiment, though not required, rails 13 and a latch 11 provide a secure attachment mechanism to devices such as drills, saws, charging stations, etc. Likewise, although, one specific configuration of rails 13 and latches 11 is shown, any known attachment configuration is anticipated.

Although not shown, for completeness, often such battery packs 30 include other devices such as electronic circuits that prevent over current, over voltage, under voltage, control charging, prevent over-temperature situations during charging, etc. All such devices are known and present in some battery packs, but have been left out for clarity reasons.

A one-way valve 50 is mounted in a hole 21 in the wall 22 of the enclosure. Although any industrial one-way valve 50 is anticipated, the exemplary one-way valve 50 as shown in FIG. 6 is a spring-loaded, seated ball type valve. In such, a spring 52 or other resilient member urges a ball 56 or other shaped object onto a seat 60. The spring 52 maintains pressure on the ball 56, holding it tightly against the seat 60, preventing external materials from entering the battery pack 30 independent upon external pressure, atmospheric conditions and orientation of the battery pack 10. The spring 52 provides sufficient force to prevent the ball from unseating during internal pressure changes that occur for heating and cooling of the battery cells 20 during use and/or charging. The force of the spring 52 is overcome by extreme pressure from within the battery pack 30 that occurs, for example, when a battery cell 20 failure occurs and gases are vented, thereby the ball 56 lifts from the seat 60 and the gases escape through the vent openings 54.

Another, optional, aspect of the improved venting system is a flexible or semi-rigid conduit 36 that surrounds the one-way valve 50. The flexible or semi-rigid conduit 36 reduces or prevents biohazard material from collecting within and around the one-way valve 50. In a preferred embodiment, a first end of the flexible or semi-rigid conduit 36 is mounted within the same hole 21 as the one-way valve 50 and a distal end of the flexible or semi-rigid conduit 36 is covered by the latch 11, thereby covering the flexible or semi-rigid conduit 36 and preventing or reducing material introduction into and around the one-way valve 50.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A battery pack comprising:
an enclosure;
one or more battery cells held within the enclosure;
a means for connecting the battery cells to a device to be powered;
a one-way check valve, the one way check valve fluidly connecting an area within the enclosure with an atmosphere outside of the enclosure, the one-way check valve allowing pressurized fluids to flow out of the enclosure and the one-way check valve preventing pressurized fluids from flowing from the atmosphere into the enclosure.

2. The battery pack of claim 1, wherein the one or more battery cells is two or more battery cells and the battery pack further comprises interconnecting conductive paths, each interconnecting conductive path connecting battery terminals of the batteries in series, parallel or series-parallel.

3. The battery pack of claim 1, wherein the one-way check valve consists of a valve seat, a valve ball, a vented enclosure and a spring, the spring urging the valve ball against the valve seat, the valve seat fluidly interfaced to the area within the enclosure.

4. The battery pack of claim 1, further comprising a semi-rigid conduit fluidly, a first end of the semi-rigid conduit coupled to the one-way check valve.

5. The battery pack of claim 4, further comprising a battery pack latch mechanism, the battery pack latch mechanism releasably securing the battery pack to the device to be powered.

6. The battery pack of claim 5, wherein an end of the semi-rigid conduit distal from the first end abuts a bottom surface of the battery pack latch mechanism, thereby covering the semi-rigid conduit and reducing introduction of foreign matter into the semi-rigid conduit.

7. A method of reducing battery pack failure during heat sterilization, the method comprising:
providing one or more battery cells, the battery cells interconnected to provide power to a device;
connecting the battery cells to connection terminals by a plurality of conductors, the conductors passing through the insulative layer; and
enclosing the battery cells into a battery pack, the connection terminals accessible from outside of the battery pack;
affixing a one-way check valve into a hole in a wall of the enclosure, the one way check valve fluidly connecting an area within the enclosure with an atmosphere outside of the enclosure, the one-way check valve allowing pressurized fluids to flow out of the enclosure and the one-way check valve preventing pressurized fluids from flowing from the atmosphere into the enclosure;
whereby pressurized steam presented during a heat sterilization cycle is prevented from entering the battery pack by the one-way check valve while abnormal pressure from within the enclosure escapes through the one-way check valve and to the atmosphere.

8. The method of claim 7, wherein the one or more battery cells is two or more battery cells and the battery pack further comprises interconnecting conductive paths, each interconnecting conductive path connecting battery terminals of the batteries in series, parallel or series-parallel.

9. The method of claim 7, wherein the one-way check valve consists of a valve seat, a valve ball, a vented enclosure and a spring, the spring urging the valve ball against the valve seat, the valve seat fluidly interfaced to the area within the enclosure.

10. The method of claim 9, further comprising a semi-rigid conduit fluidly, a first end of the semi-rigid conduit coupled to the one-way check valve.

11. The method of claim 10, further comprising means for latching the battery pack to the device to be powered, the means for latching the battery pack releasably securing the battery pack to the device to be powered.

12. The method of claim 11, wherein an end of the semi-rigid conduit distal from the first end abuts a bottom surface of the battery pack latch mechanism, thereby covering the semi-rigid conduit and reducing introduction of foreign matter into the semi-rigid conduit.

13. A battery pack comprising:
an enclosure;
one or more battery cells held within the enclosure;
a means for connecting the battery cells to a device to be powered;
a one-way check valve, the one way check valve sealedly installed in a wall of the enclosure, the one-way check valve fluidly connecting an area within the enclosure with an atmosphere outside of the enclosure, the one-way check valve allowing pressurized fluids to flow out of the enclosure and the one-way check valve preventing pressurized fluids from flowing from the atmosphere into the enclosure;
wherein the one-way check valve comprises a valve seat, a valve ball, a vented enclosure and a spring, the spring urging the valve ball against the valve seat, the valve seat fluidly interfaced to the area within the enclosure.

14. The battery pack of claim 13, wherein the one or more battery cells is two or more battery cells and the battery pack further comprises interconnecting conductive paths, each interconnecting conductive path connecting battery terminals of the batteries in series, parallel or series-parallel.

15. The battery pack of claim 13, further comprising a semi-rigid conduit fluidly, a first end of the semi-rigid conduit coupled to the one-way check valve.

16. The battery pack of claim 15, further comprising a battery pack latch mechanism, the battery pack latch mechanism releasably securing the battery pack to the device to be powered.

17. The battery pack of claim 16, wherein an end of the semi-rigid conduit distal from the first end abuts a bottom surface of the battery pack latch mechanism, thereby covering the semi-rigid conduit and reducing introduction of foreign matter into the semi-rigid conduit.
